(19) United States
(12) Patent Application Publication
(10) Pub. No.: US 2007/0068063 A1
(43) Pub. Date: Mar. 29, 2007

(54) Portable live well/bait well for a boat

(76) Inventor: Roger Simpson, Saskatoon (CA)

Correspondence Address: Mr. Adrian D. Battison;Ade & Company Inc., 1795 Henderson Highway, P.O. Box 28006, Winnipeg, MB, R2G 4E9, CA

(21) Appl. No.: 11/524,903

(22) Filed: Sep. 22, 2006

Related U.S. Application Data
(60) Provisional application No. 60/721,548, filed on Sep. 29, 2005.

(51) Int. Cl. A01K 97/05; A01K 97/20

(52) U.S. Cl. 43/57; 43/55

(57) ABSTRACT

In a boat that was not designed for or required a live well, a built-in tank, for the holding of newly caught fish, a portable tank will serve as a live well that will hold fish that are caught and a bait well that would receive minnows or leaches. An electric pump powered by a battery of the boat or portable battery pumps water from the lake into the tank to fill, aerate and circulate the water in the tank. An electric pump powered by a battery of the boat or portable battery pumps water out of the tank and provides for overflow. A series of three valves control the water intake, water overflow and re-circulation of water in the tank. These operations are controlled by the open or closed combinations of the three valves. The majority of the live well is to receive newly caught fish with the smaller portion of the live well to serve as the holder for live bait. Aerated water filters throughout the entire live well.

This application claims the benefit of priority under 35 U.S.C. 119 from Provisional Application 60/721,548 filed Sep. 29, 2005.

This invention relates to a portable live well or bait well for use in boats that were not designed and or built with a live well in them.

### BACKGROUND OF THE INVENTION

A live well or bait well serves as a container that can store newly caught fish and live bait, in good physical condition.

In fishing tournaments it is required that any fish that are caught must be returned to the water at any time or at the end of the tournament. It is because of this requirement that fish caught must be kept alive and in good condition for an extended period of time. With the pressure of more people out on our local lakes getting into fishing it is up to all of us to do our part to practice good stewardship of our natural resources.

Many boats are manufactured for this purpose with a live well formed as a tank as part of the structure with piping through the side of the boat to fill and empty the tank and to provide circulation of water within the tank.

However many boats do not have this facility or are intended to be used for multiple purposes so that the presence of such a live well when not required is an inconvenience.

### SUMMARY OF THE INVENTION

It is one object of the present invention to provide a portable live well would allow more people to enjoy the sport of fishing, whether in a tournament or just out with their families and friends.

According to the invention there is provided a portable live well for mounting in a boat having a boat well and a side rail, the live well comprising:

a portable tank shaped and arranged to sit in the boat well below the side rail;

a pump located in the tank for extracting water from the tank;

a drain line arranged to extend over the side rail;

a return line for injecting water into the tank above water level for aerating the water;

at least one valve operable for directing the water from the pump to the return line or to the drain line as required.

Preferably, in a more expensive model of the construction, there is provided a filling line for filling the tank from water surrounding the boat.

Preferably the filling line is connected to a filling pump at the tank.

Preferably the filling pump supplies the water through the return line.

Preferably the drain line and the filling line each include a valve and wherein there is provided a bypass valve connected in a bypass connection between the filling line and the drain line.

Preferably the three valves are located at the side rail.

Preferably there are switches for the pumps at the tank.

Preferably the tank includes a separate mesh section through which the water from the tank can penetrate for receiving and separating live bait from the fish in the tank.

Preferably the separate section is formed as an extension portion on one side wall of the tank.

### BRIEF DESCRIPTION OF THE DRAWINGS

One embodiment of the invention will now be described in conjunction with the accompanying drawings in which:

FIG. 1 is an isometric view partly cut away of a boat with a portable live well according to the invention installed therein.

FIG. 2 is an enlarged view showing the arrangement of pipes and pumps to feed water into and out of the live well.

FIG. 3 is a similar view to that of FIG. 2 showing a modified simplified arrangement of the live well system.

In the drawings like characters of reference indicate corresponding parts in the different figures.

### DETAILED DESCRIPTION

A portable live-well for use in fishing comprises a tank 10 with upstanding side walls 11 and a flat base 12 for mounting as a separate item in a boat schematically indicated at 13. The tank can be made of any suitable light weight material which can accept the loads of the water contained within the tank when sitting on the floor of the boat and of being transferred when empty or mainly empty from the boat to a storage location when required. In this way the tank can be removed and the boat returned to other uses without the tank.

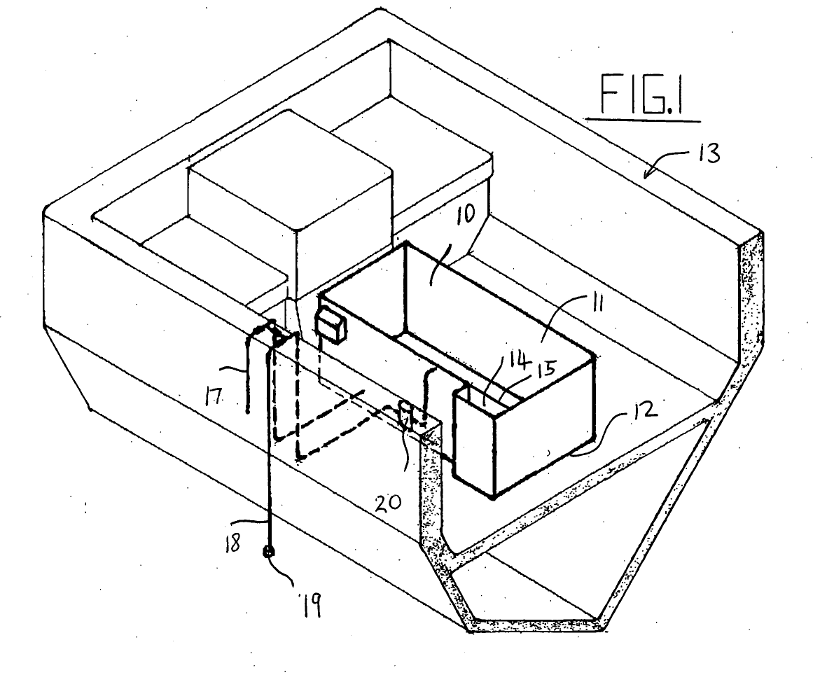

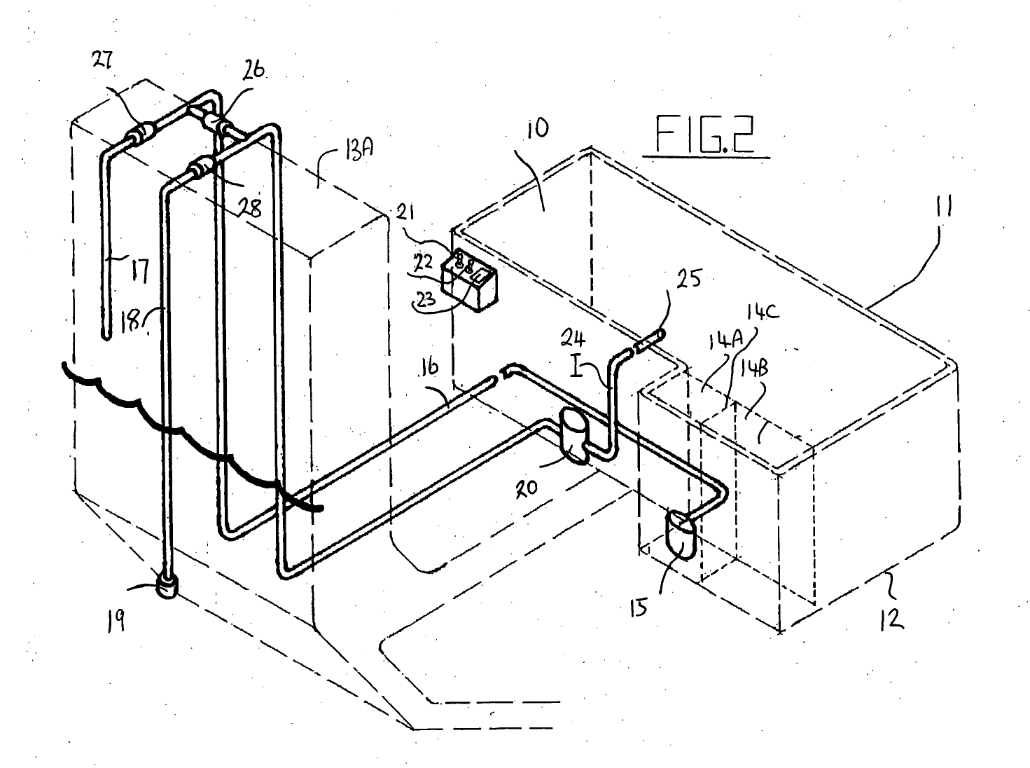

In the primary model shown in FIGS. 1 and 2, the tank 10 is generally rectangular with a flat base for sitting in the well of the boat as a portable tank which can be lifted in and out of the boat. The tank may include handles (not shown) on the ends for this purpose. On one side wall of the tank there is an extension portion 14 which projects outwardly from the side wall and defines a separate section forming a bait well, separated from the main body of the tank by a mesh screen 15 which allows the penetration of water from the tank while separating the fish from live bait contained within the separate section of the bait well. The bait well 14 may be divided into two separate sections 14A, 14B for different types of bait with a central divider mesh screen 14C. The bait well has a bottom at the same plane as the bottom 12 and has sides parallel to the sides of the main body of the well. In the example shown the bait well extends only part way along the well but it may be larger and extend along the full length.

A discharge pump 15 is located in the tank and in the example shown is preferably located within the bait well section 14 so as to generate water flow through the system and through the live well tank into the bait well section. A line extends from the pump 15 as indicated at 16 as a drain line and extends over the bottom of the boat to the side wall where it passes up the side wall over the top rail of the side wall to a discharge or drain line section 17 depending over the side of the boat for discharging water from the tank into the water surrounding the boat.

An inlet line 18 includes the inlet filter 19 which is located on the end of the line and is suspended within the water so that water can be drawn by the inlet pump 20 at the tank operated by a switch 21 of the switch system 21, 22 and 23 so that water is fed into the tank 10 through a return line 24 having an aeration nozzle 25 at the end which forms a spray over the surface of the water within the tank so that the water is aerated as it enters the tank.

A bypass valve 26 extends across in a bypass between the drain and inlet lines at the top rail. Thus the three valves 27, 28 and 26 are located on the top rail 13A of the boat 13 for ready access. Thus the water can be re-circulated through the pumps 15 and 20 by extracting at the pump 15 through the line 16 and can be bypassed through the valve 26 to return to tank 10 through the inlet return 24 with the aeration nozzle 25. In this way the lines are filled with water from the tank to the side rail which is above the height of the water in the tank. Thus when the valve 27 is closed and the valve 26 is opened, the lines remain filled so that water is drawn into the pump 20 without the expense of providing a self-priming pump as the pump 20.

When the valve 28 on the intake line 18 and valve 27 on the outlet line 17 are in an open position and the centre valve 26 on the bypass line 26A bridging the inlet and outlet, are in a closed position lake water will be pumped into the live well and then be pumped out of the live well back into the lake. When the valve 28 on the intake line 18 and the valve 27 on the outlet line 17 are in the closed position and the centre valve 26 is in an open position the water will circulate around a closed loop through the live well. With the valves in this configuration the live well will not be getting any fresh water from the lake, but will re-circulate through the aeration nozzle and re-aerate the existing water.

Because the intake pump 20, if it is a pump which is not self-priming, as preferred, can not suck water into the live well, the pump 20 must be primed by manually adding a few gallons of water to the tank. By operating both pumps 20 and 15 this will allow water to flow through the closed loop and create suction to the intake pump 20. By opening valve 28 on the intake line the circulating suction will pull water up the intake line from the lake. Now that the water is being pumped into the live well it can be filled. While the live well is filling, the centre valve 26 can be turned to the closed position and the outlet pump switch 21 can be shut off until the tank is nearly full.

Once the live well is nearly full the outlet pump switch 21 can be turned on and valve 27 on the outlet line can be turned to the open position to allow water to be pumped back into the lake. This will now have completed the filling process and allow fresh lake water to circulate into the live well and be pumped back out into the lake. To regulate the flow of water in or out of the tank the on/off toggle switches 21 and 22 can be operated independently.

An automatic timing device (not shown) can be provided to allow the circulation of water to be operated independently of the two toggle switches. The timer can be set to cycle on and off at pre-set intervals. The pumps can also be controlled independently by the two on/off toggle switches which are manually operated. As newly caught fish are added into the live well the water level must be decreased. This can be achieved by turning off the toggle switch to the inlet pump 20, which will allow the outlet pump 15 to drain water out of the live well to a suitable level. Once this level has been met the inlet pump 20 can be switched back on. To increase the water level in the live well, the outlet pump 15 is turned off until the water level in the live well has risen and then the outlet pump 15 is turned back on.

There may be provided a hinged lid at the top of the livewell and/or the bait well to close off the open top of the tank.

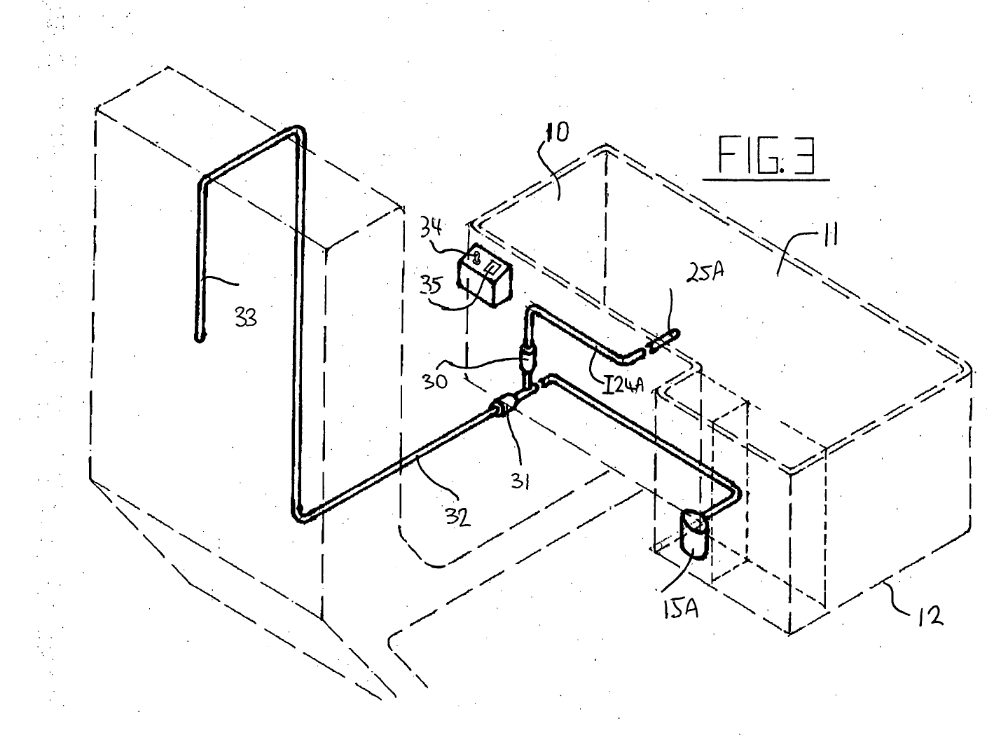

In FIG. 3 is shown an alternative arrangement of a simplified nature in which the filling pump is omitted so that the discharge pump indicated at 15A acts either to discharge the water through the drain line 16A back to the water surrounding the boat or to return the water through a valve 30, return line 24A and aeration nozzle R back into the tank L. When it is desired to empty the tank, the valve 30 is closed and an additional valve 31 is opened to discharge the water through a line 32 to a discharge 33. The system is operated by switches 34 and 35. This arrangement is simplified in that it uses only a single pump and only two valves but requires the tank to be filled using an alternative system.

The pumps are simple inexpensive electric pumps driven by battery power from a dedicated battery or from the boat electrical system.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. Apparatus for use in fishing comprising:
a boat having a boat well and a side rail;
a portable live well separate from the boat and arranged for mounting in the boat well of the boat and for ready removal from the boat, the live well comprising:
a portable tank shaped and arranged to sit in the boat well below the side rail;
a pump located in the tank for extracting water from the tank;
a drain line arranged to extend over the side rail;
a return line for injecting water into the tank above water level for aerating the water;
and at least one valve operable for directing the water from the pump to the return line or to the drain line as required.

2. The apparatus according to claim 1 wherein there is provided a filling line for filling the tank from water surrounding the boat.

3. The apparatus according to claim 2 wherein the filling line is connected to a filling pump at the tank.

4. The apparatus according to claim 3 wherein the filling pump supplies the water through the return line.

5. The apparatus according to claim 4 wherein the drain line and the filling line each include a valve and wherein there is provided a bypass valve connected in a bypass connection between the filling line and the drain line.

6. The apparatus according to claim 5 wherein the three valves are located at the side rail.

7. The apparatus according to claim 4 wherein there are switches for the pumps at the tank.

8. The apparatus according to claim 1 wherein the tank includes a separate bait section through which the water from the tank can penetrate for receiving and separating live bait from the fish in the tank.

9. The apparatus according to claim 8 wherein the separate section is formed as an extension portion on one side wall of the tank.

10. The apparatus according to claim 8 wherein the separate section is separated from the tank by a screen which allows passage of water but prevents the passage of fish or bait.

11. Apparatus for use in fishing comprising:
a boat having a boat well and a side rail;
a portable live well separate from the boat and arranged for mounting in the boat well of the boat and for ready removal from the boat, the live well comprising:
a portable tank shaped and arranged to sit in the boat well below the side rail;
a first pump located in the tank for extracting water from the tank;
a drain line extending from the first pump over the side rail;
a second pump located outside the tank for pumping water into the tank;
a fill line extending from over the side rail to the second pump;
a return line extending from the second pump into the tank for injecting water into the tank, the return line terminating above water level and including an aeration nozzle for aerating the water;
a by-pass line interconnecting the return line and the fill line at the rail;
and three valves arranged respectively in the fill line, the discharge line and the by pass.

12. The apparatus according to claim 11 wherein the three valves are located at the side rail.

13. The apparatus according to claim 11 wherein there are switches for the pumps at the tank.

14. The apparatus according to claim 11 wherein the tank includes a separate bait section through which the water from the tank can penetrate for receiving and separating live bait from the fish in the tank.

15. The apparatus according to claim 14 wherein the separate section is formed as an extension portion on one side wall of the tank.

16. The apparatus according to claim 14 wherein the separate section is separated from the tank by a screen which allows passage of water but prevents the passage of fish or bait.

17. The apparatus according to claim 14 wherein the first pump is located in the separate section of the tank.
